(19) United States
(12) Patent Application Publication
(10) Pub. No.: US 2005/0229961 A1
(43) Pub. Date: Oct. 20, 2005

(54) Mechanical walker stabilizer

(76) Inventors: Shigeo Takizawa, Fujisawa (JP); Hajime Takada, Yokohama (JP)

Correspondence Address: Shigeo Takizawa, 4-24-5 Shounandai, Fujisawa, 252-0804, JP

(21) Appl. No.: 11/094,886

(22) Filed: Mar. 30, 2005

(30) Foreign Application Priority Data
Mar. 30, 2004 (JP) 2004-97789

(51) Int. Cl. B60B 33/00; A61H 3/00

(52) U.S. Cl. 135/67

(57) ABSTRACT

This invention, the mechanical gait stabilizer comprises a sensor, a supporting structure, transmitters and brakes systems enable to brake wheels without any control at the time of people to use a walker with; detecting frictional force by said sensor where a spring detecting changes of floor friction coefficient through changing of frictional force of a sled that touched on a floor and in order to stable the movement of the sled, providing a sled upper structure guidance section on the sled in order to enable said sled upper structure guidance section to move defined area, and increasing a strength that causes from a stretch of spring, which occurs from changes by the detected friction force, by using the lever as a transmitter.

### FIELD OF INVENTION

This invention is a Mechanical walker stabilizer to stabilize the walking movement of users by controlling the optional wheel activity, by attaching the device on a walker in force to recover gait function of a handicapped person, and those who carry out gait training by oneself without a special caregiver at home.

### BACKGROUND INVENTION

So far, when any object, such as a utensil or a structure is moved, a caster is used as a means to meet a wheel and the transit plane.

When the existent caster is not available because of an obstacle in the path of its transit plane, obstacles such as utensils or structures are moved, the existing caster has a big wheel installed directly on the object used for traveling over obstacles.

When a big wheel is not available for the surrounding conditions the existing caster could not travel over obstacles with the little wheel.

This applicant has applied for the invention of a walker with a caster installed and kept a sled at the bottom of the frame body under Japanese patent application JP 7-236670.

It is an example to correct the above mentioned inconvenience in order to move with stability inside a building that has an abundance of traversing obstacles such as the edges of TATAMI mats or some other types of materials.

This is an invention that corrects the inconvenience experienced when a handicapped person falls down due to the rotation of the wheels and to enhance the ability to traverse surfaces such as steps, particularly when using a walker at home.

But there is no structure to amplify any frictional force detected by the detection spring, using a lever, and to control the wheels.

Also, a caster with a sled; to stably traverse bumps by enabling the sled to move backward, forward and vertically with angle modulation, to make a grounding department area adjustable, and change frictional force and control speed, was registered as JP H 10-No.98084, and patented as patent 2979170.

This invention uses flexible material for the sled, in order to enable the grounding department area of the sled to change.

By making it adjustable, it enables changes in the frictional force, and the ability to control acceleration.

In the caster, the bottom face of a stable supporting leg is formed according to transforming area, making the moving direction of the caster a front, curving up the bottom face of the stable supporting leg of the back, in several angles of gradients.

By controlling the control utensil attached on the stable supporting leg and the sled, the sled is characterized by making the sled movable.

On the sled of the caster, a hole is made, and by the hole the bottom areas of the wheels approach the transferring area.

By having the grounded area of the sled in front of the wheels, and the controls of controlling utensils, grounding department area can increase and decrease, using vertical movements.

This controlling utensil is made of rubber in the embodiment. A spring may be used but it is not structured for amplifying the fictional forth spring has detected, using the lever for leverage and to control the wheel, nor to use it as a sensor nor a brake system to obtain its purpose in controlling the added acceleration.

Also, one of us applicants has applied a caster JP 2001-1704; a caster with sled and wheels grounded.

The sled can move from a front downward angle to a back downward angle, by changing its gradient angle, the grounding pressure of the sled can be changed from a grounded position to an uplifted position.

This application and the above U.S. Pat. No. 2,979,170 have been patented in U.S and AU. As U.S. Pat. No. 6,625,846 and Australian patent 759698.

The patent 2979170 has a sled and control utensil made of rubber, similar to this register, not changing a gradient angle of the sled, in the form of grounding the sled and wheels changing the grounding frictional force of the sled.

Also, JP 2001-1704, U.S. Pat. No. 6,625,846, and Australian Patent 759698 too contains driving gear in which changing the gradient angle of the sled changes the grounding pressure until the wheels are ungrounded.

It is also characterized in detecting the change of the sled's gradient angle when changed, and output its data outside,

But neither of them has a role of frictional force sensor, both for the lever as leverage to amplify the fictional forth the spring has detected, and to control the wheels.

Also, there is JP H 11-276535 that aims to provide a walker wheel device which; certainly reacts to the users' braking demands, is safe, carries enough durability for long-term usage, and requires no maintenance.

Above JP H 11-276535 put brake on wheel (5) in system of when electromagnetic brake (18) excites, a stator (22) near the bracket sidepiece (16a), vacuum up armature (21).

When of the electromagnetic brake (18) is released, the armature (21) departs from the stator (22) by a plate vane (10), and forms a gap between the stator (22) and armature (21).

It is adopted to control this gap by screwing an adjusting screw (31) of the wheel (17), and elastic deform a bracket (16).

From this, to stably move the walker, JP 2000-210354 that provide a walker wheel device that certainly reacts to the users' braking demands, and carries enough durability for long-term usage, uses a number of gears (6), (8), (9), (11), (12), and (16), to transmit the rotation of wheel (1), and electromagnetic brake (16), to brake the rotation of the wheel (1).

Also, from the above, there is a self-gait-supportive equipment in providing a walker wheel device which contains the JP 2000-210352 walker wheel device and the self-gait-supportive equipment with the device fixed, providing the same device, non-contact form using eddy current, and able to control the braking force, so that the user can control braking force with a hand, and to provide self-gait-supportive equipment which can indicate the use of force, it provides a reduction gear to reduce the speed of the wheel (1) and pertinent wheel,

More, the previous item, included an independent walking support machine provided with the wheel device for the JP 2000-210352 walker and the same device in the bottom, it is provided with the same device by providing the wheel device for the walker which can adjust the system power by a non-contact-type in which a whirlpool electric current was used by the user's operation part at hand, for system power adjustment

But JP H 11-276535, JP 2000-210354 and JP 2000-210352 are taking in the wheel controlling method as in this application, but does not contain a sled that has a role as a sensor, nor a lever as leverage to amplify the fictional forth the spring detected, and to control the wheels automatically.

As an example of an existing caster, JP S 64-44301 was reported in the Patent Gazette, but its purpose is the same as the existing casters, to attach sled material only on the anterior portion of the caster to aid getting over an obstructive step when rolling and running a flat surface.

Also it controls the proceeding direction of the sled and the caster, so that it will not be impossible to get over a step, due to caster movement.

At the same time, to roll and run a flat surface it has designed a stopper to secure sled material, and its realization is being brought to attainment.

There also is JP S 64-44301 for getting over a step.

And as an example of an existing caster, there is JP U S 50-140166 in the Patent Gazette with the purpose of lifting weighing objects to a desired height.

There also is an investigation of a pushing carrier with sled, JP H 5-221321, which uses a sled for use in snow.

Above JP S 64-44301, JP U S 50-140166 and JP H 5-221321 contain sleds, but do not contain a system for a lever as leverage to amplify the fictional forth the spring detected, and to control the wheels automatically. Either of them has dissimilar construction or factors.

Up to now, in cases of disturbance in gait by reasons such as femoral neck fractures of elderly, lumbar pain from before injury, vertebral curvature, muscular weaken, or rheumatism, there was an alternative form of walker, which was supported at three or four points by providing leg poles that were formed surrounding the front and the sides in order to support a independent gait and provide training for walking by moving one's own feet.

The alternative form walker is for the handicapped to promote gait training by gripping an upper support pole in a standing posture, or by bending forward to tuck both weight pole by auxiliary when fitting in a body in an upper body support hole. It does not contain a system to control the wheels automatically, by amplifying the fictional forth the spring detected by using a lever as leverage.

As another existing example, there was a walker for the handicapped, whose gait disorder is more severe than crutch walking using a cane, but slighter than using an alternative form of walker. It was formed with four or three wheels on the undersurface of the frame; four wheels with two caster wheels in horizontal direction in front and two wheels in the back, or with total of three wheels with one caster wheel and two wheels in the back, in order to enable gait training under the supervision or lead of a doctor or a supporting person in a hospital.

With the above alternative form, there were several problems as follows; it was hard to handle and the length of stride was optional at the time because the length of stride was determined by the distance upper the limb could carry, much time was needed to train to recover to crutch walking and the protection of a supporting person was needed.

Therefore, to correct this inconvenience and to enable a stable gait for those who do not have a supporting person after leaving the hospital, or with many bumps such as doorsills in the house, one of applicants have applied Patent application JP U H03-16655 WALKER with a sled on the under surface to correct the instability of tripping by the rotation of wheels.

It does not contain a system to control the wheels automatically, by amplifying the fictional forth the spring detected by using a lever as leverage.

[Patent literature 1] JP H 7-236670 official report

[Patent literature 2] JP patent 2979170 official report

[Patent literature 3] JP 2001-1704 official report

[Patent literature 4] U.S. Pat. No. 6,625,846 official report

[Patent literature 5] Australian patent 759698 official report

[Patent literature 6] JP H 11-276535 official report

[Patent literature 7] JP 2000-210354 official report

[Patent literature 8] JP 2000-210352 official report

[Patent literature 9] JP U S 50-140166 official report

[Patent literature 10] JP S 64-44301 official report

[Patent literature 11] JP H 05-221321 official report

[Patent literature 12] JP U H 03-16655 official report

### DISCLOSURE OF INVENTION

### BRIEF SUMMARY OF THE INVENTION

Even in using the above utensils, the existing walker had the danger of accelerating and lead to tripping in the transportation of different floors such as carpets, tatami or wooden floors by a change in floor friction.

When the friction coefficient changes from a large place to a small place, even in use of JP 2001-1704, a U.S. Pat. No. 2,979,170 and a U.S. Pat. No. 6,625,846 and an Australian patent 759698 and JP H 7-No.236670, the user could not follow the friction coefficient change and in places with more bumps and where the friction coefficient is large in the top of the bump, there is a fact that it is more slippery.

Also, when using the usual four wheeled, the reason to accelerate is that the friction coefficient is small throughout the utilization time, and the friction coefficient the user needs is not secured.

It is especially prominent in moving from carpet or tatami to a wooden floor.

It originates in a frictional coefficient's variance in each situation.

A user can gain a stable gait if the frictional coefficient was fixed and stable.

To avoid the danger of acceleration tripping in traversing different floors such as carpets, Tatami, or wooden floors, by changing floor friction, this invention provides a structure to detect the floor's change of friction coefficient, apply the brake to wheels according to the detected frictional force, and stabilizing the gait.

When an object on the floor is pulled with a spring in the horizontal direction, using the fact that the stretch of the spring changes from the friction force of the floor and object, we invented a mechanical gait stabilizer, which, detects a frictional coefficient of a floor and applies the wheel brake.

Therefore it is a mechanism to brake a caster or casters on wooden floors and to lease a break of a caster or casters on carpets.

Thereby, in the case of using an optional wheel with this invention attached, the walker, which can be used in stable speed in compliance to the floor form, even through floor changes, is enabled to design and manufacture.

A change or changes of frictional force is detected by a change or changes of a length of the spring stretch by changing a frictional force or frictional forces of sled and floor in this mechanical gait stabilizer.

Converting the change(s) and the expanding lever as leverage to a brake system, applied a braking system that can control in the speed decided in advance by a brake force that the leverage gives.

A sled, which creates friction force with the floor, is used as a sensor by pasting felt on a hard sled, based on past experience and by controlling the strength of the spring to reflect to a lever as leverage.

The sled material may be anything, and the felt can be any if a certain friction force is prospective, such as a thin synthetic carpet.

A supporting structure and sensor are connected by a spring. The spring stretch changes depending on the change of friction force the sensor detects from the floor.

Amplification of tension, which occurs by the stretching of the spring through the principle of leverage, brakes wheels.

A brake form is a wheel tread brake, and brake pad is pressed from frontward of a wheel or wheels.

The sensor is a working point of the leverage, and a brake pad is a power point.

There are two links of levers, and the two links of levers brake the both wheels of the mechanical gait stabilizer attached at the same time.

When the floor is a carpet, sensor is dragged backward due to the friction.

At this time, a brake pad becomes the condition of a brake release because it works in the opposite direction from the wheel.

A sensor is pulled in the direction to the wheel on the wooden floor because a tension force of the spring grows bigger than a frictional force, which a sensor receives from the floor.

In conjunction with that movement, brake pad is pressed against the wheel, and becomes the condition in which the brake is applied.

In consequence, in the use examination of the mechanical gait stabilizer, tension of pulling by a rope with no forward elasticity was measured instead of an experiment of the user's motive force.

The measured value showed constant value in all the measurement sections, and that tension could prove the effect of this invention

When a sensor is moved on the floor, the sensor as a detection device is secured with two springs, and it provides an unstable movement.

To restrict the movement of every direction and the vertical direction without influencing detection was needed.

By providing a supporting structure, the supporting structure works as a guide structure to limit the range of motion of a sensor and could stabilized the movement of the sensor.

Therefore excessive power was never added to the spring, and it was able to prevent any breakage due to over extendedness or twist.

### BRIEF DESCRIPTION OF THE DRAWINGS

FIG. 1 is a perspective figure, which shows substantial parts of a mechanical gait stabilizer.

FIG. 2 is an elevation view, which shows substantial parts of a mechanical gait stabilizer.

FIG. 3 is a reference figure, which shows substantial parts of a sensor.

FIG. 4 is a reference figure, which installs a mechanical gait stabilizer (W) to a walker in proceeding direction of (F).

FIG. 5-1 is the reference figure, which shows a sensor, a lever as leverage and the usage condition of a brake system, of when a mechanical gait stabilizer was used on the floor with a big frictional force.

FIG. 5-2 is the reference figure, which shows the sensor, a lever as leverage and the usage condition of a brake system, of when a mechanical gait stabilizer was used on the floor with a small frictional force.

FIG. 6 is a chart, which shows a change in the frictional force.

FIG. 7 is a chart, which shows a change in the frictional force.

### DETAILED DESCRIPTION OF THE INVENTION

Hereinafter, the present invention will be concretely described related to this embodiment.

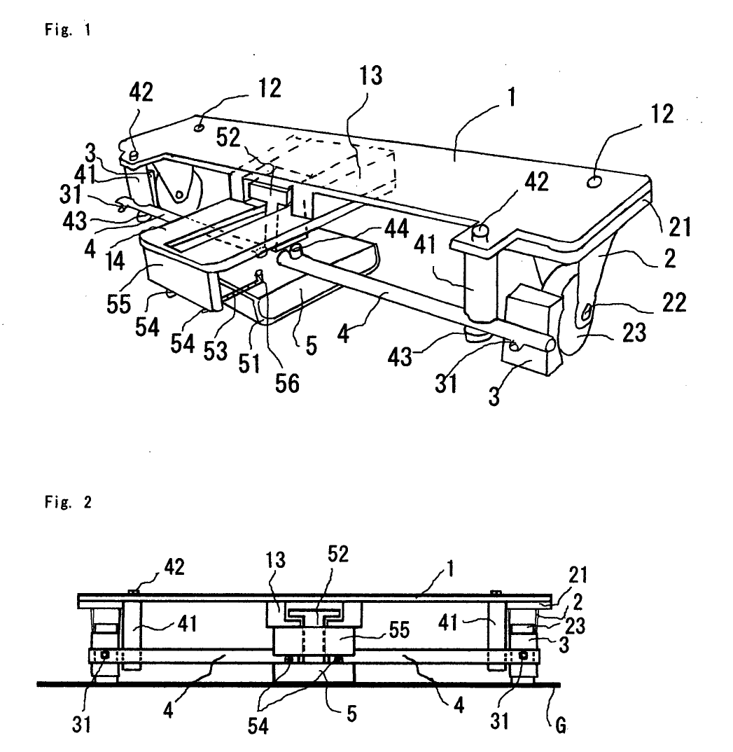

The upper structure (1) of FIG. 1 is an upper structure of the mechanical gait stabilizer, and is made of iron.

Its size has a width of 480 mm and length of 85 mm corresponding to the width of the walker.

As for the quality of the material, any kind of material may be used if a walker such as aluminum, and reinforced plastics attached on the top are supported.

A supporting structure basis (13) on the both sides and a sled upper structure guidance section (14) are made of iron, and it is welded to an upper structure (1).

The space between the left and right supporting structure basis (13) is 55 mm.

A hole (12) is a walker leg setting hole.

The both sides of a sled upper structure guidance section (14) are attached 25mm away from each other.

Upper structure (1), both side of supporting structure basis (13) and both side of sled upper structure guidance section (14) are welded integral construction, but it also could be made constructive in sections by screws.

By providing the supporting structure mentioned above, a sensor consists of a sled (5), a friction material (51) and a sled upper structure (52) enables sensor to move in the range of motion in any direction stably because the supporting structure mentioned above works as guide structure to limit the range of motion of sensor.

The excessive power was never added to the spring due to the sensor's movement became stable, and it was able to prevent any breakage due to over extendedness or twisting.

The wheel portion consist of wheel retentive portions (2), wheels (23), axles (22) and installation materials (21), and it is installed to an upper structure (1).

The wheels of this embodiment use rubber wheels with a diameter of 65 mm.

A fixed wheel structure is used in this embodiment, but ball type casters may be used.

Any types of casters may b used if the casters are restricted to rotating inside the range about 120 times forward in order to brake wheels.

Brakes (3) are installed on levers (4) with installation materials (31).

A brake (3), which is a wheel tread brake consists of super high-molecular weight polyethylene and is used a brake pad of the size of length 45 mm breadth 28 mm.

A super high-molecular weight polyethylene is used in this embodiment, but any kind of material, for example aluminum, may be used if it has the ability to slide.

Also a shoe brake can be used as a form.

The electromagnetic battery-type brake as well can be used if enabling the brake power to change along with a change in pressure of leverage.

A lever (4) with the ability to rotate is connected to a sled (5) as a sensor; by the axis point tying utensil (44), and the other side of said lever (4) is being installed on a leverage shaft (43) of a leverage shaft guide (41), which is attached with a nut (42) in an upper structure (1).

And, both sides are bilaterally symmetrical.

Leverage ratio given to the brake (3) of the lever (4) is leverage ratio 5.9: 1 due to the position of a leverage shaft (43).

A sensor consists of the sled (5), frictional materials (51) as a detection part, sled upper structure (52), springs (53), spring stops (54), a spring stop maintenance device (55) and a spring tying utensil (56).

The material of a sled (5) is an acrylic board; with dimensions of 80 mm×120 mm×20 mm.

The weight is 725 g including the frictional material (51) and sled upper structure (52).

And, if constant friction is given to it, anything, in such cases as aluminum, can be used, and a form also could be midair.

Sled upper structure (52) is glued to the upper part of sled (5).

Sled upper structure (52) is the size that can be stored in the maintenance device. And size of the sled upper structure (52) in this embodiment the upper part has a width of 50 mm, length of 60 mm and 7 mm thick, the lower part has a width of 20 mm, length of 60 mm height of 50 mm.

Size in this embodiment is the size, which is suitable for the frictional force by the spring ratio and the material quality of the detection part, and it is not limited to this size.

It is arbitrarily changeable by the material quality of the detection part, a spring ratio and leverage ratio.

Two springs (53) are placed bilaterally symmetrical, size is a wire diameter 0.6 mm, external diameter 7 mm, length 40 mm, and a spring constant 0.1097 N/mm, with stainless steel.

Though springs accommodate with said sensor as for this embodiment, the material, its length and a form are arbitrarily changeable.

One end of a spring (53) is stopped in the bottom part of the spring stop maintenance device (55) arranged in front of a sled upper structure guidance section (14).

The other end a spring (53) is stopped in the upper part of the sled (5) as a sensor.

FIG. 2 is an elevation view, and a floor (G) to use is shown.

Upper structure (1) is an upper structure of a mechanical gait stabilizer upper structure in FIG. 1 in the figure.

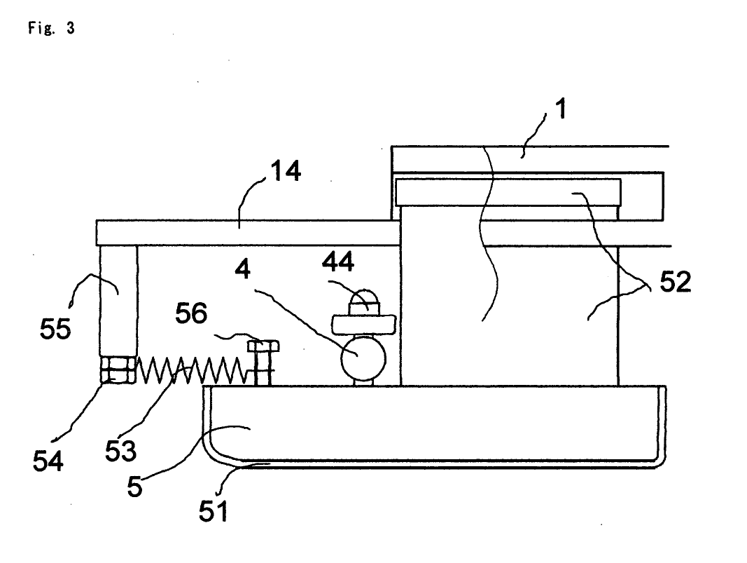

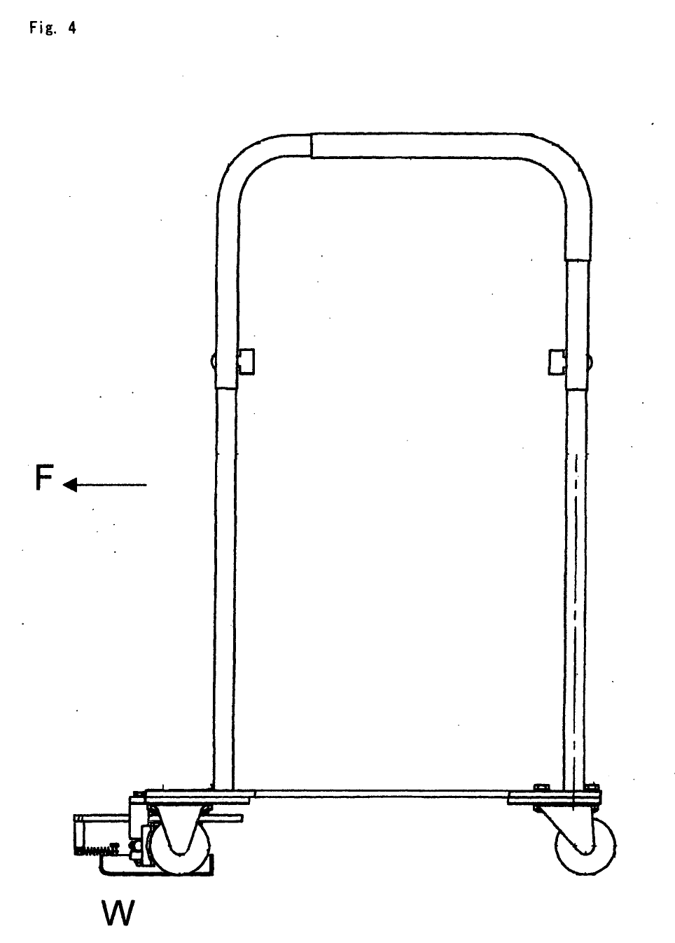

FIG. 3 is a reference figure, which shows substantial parts of the sensor.

Upper structure (1) is the mechanical gait stabilizer upper structure in FIG. 1.

A sled upper structure guidance section (14), a lever (4), an axis point tying utensil (44), a detecting sled (5), a frictional material (51) as a sensor, a sled upper structure (52), a spring stopper (54), and a spring stopping supporting structure (55), and a spring tying utensil (56) are the same as in FIG. 1.

FIG. 4 is a reference figure, which installs a mechanical gait stabilizer (W) to a walker in proceeding direction of (F).

In this embodiment rear wheels are made caster structure so that a direction can be freely changed.

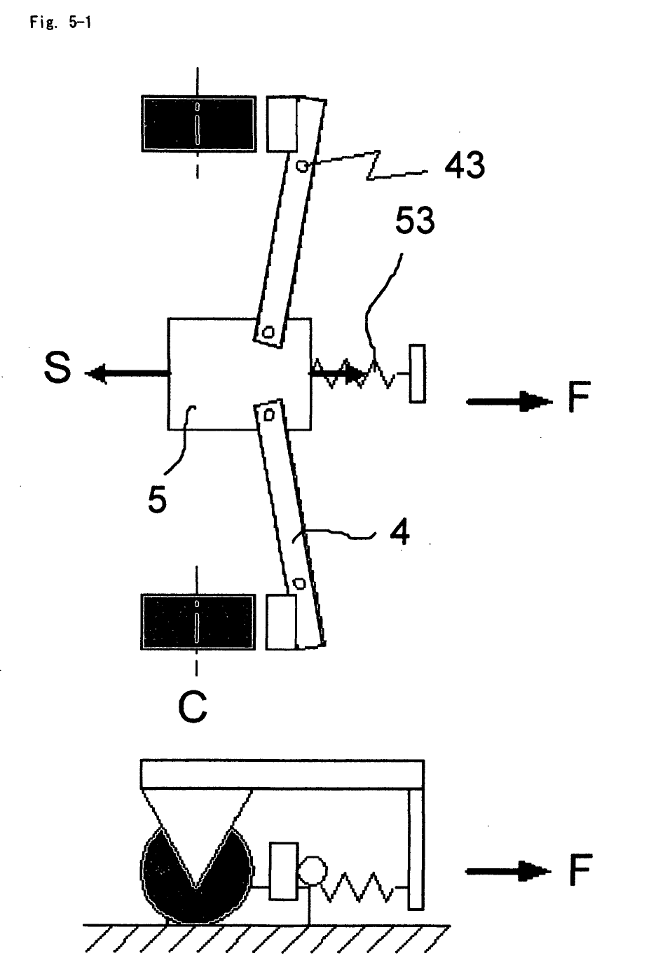

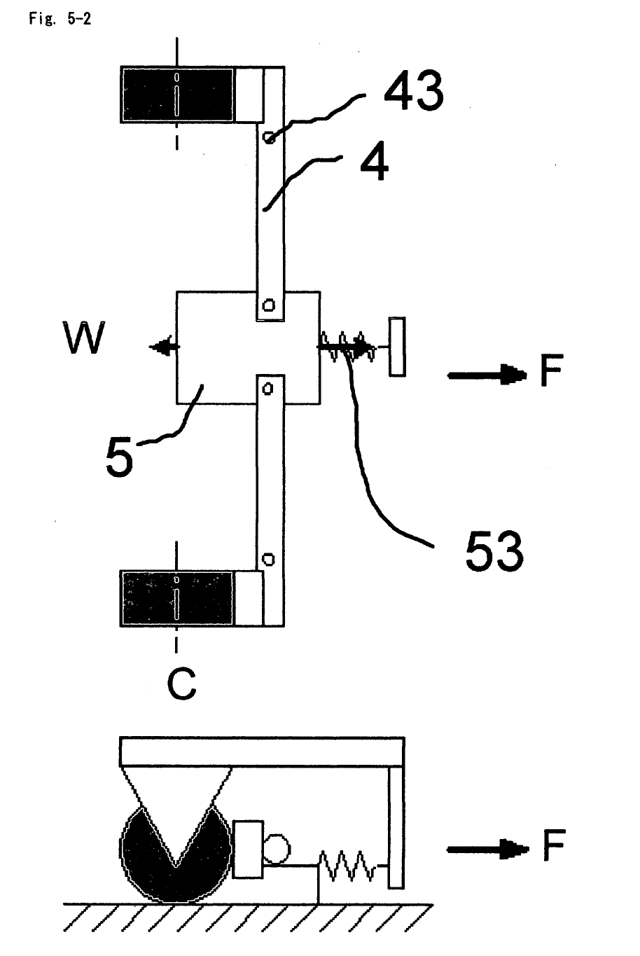

FIG. 5-1 shows;

The proceeding direction is (F), and
when the wheel in position (c) and a sled (5) as a sensor detect large frictional force,
sled (5) is pulled backward,
spring (53) lengthens, then
longitudinal of the lever (4) which holds a leverage shaft (43) is shifted backward,
and does not brake on the wheel in position (c).

FIG. 5-2 shows;
the proceeding direction is (F), and
when the wheel in position (c) and a sled (5) as a sensor detect small frictional force,
sled (5) is pulled forward,
spring (53) shortens, then
longitudinal of the lever (4) which holds a leverage shaft (43) is shifted up to the parallel position,
and brake system applies on the wheel in position (c).

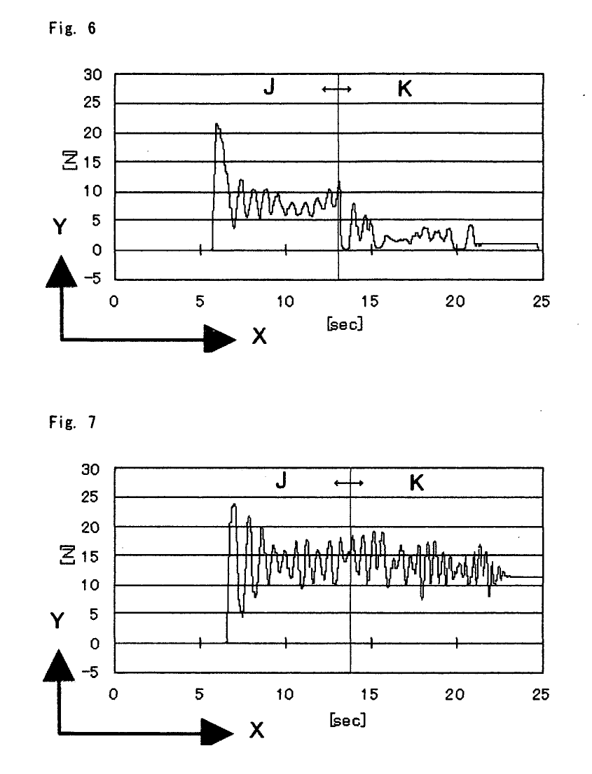

FIGS. 6 and 7 are both charts that show a change in the frictional force.

FIGS. 6 and 7 are the graph of the result of the experiment, which shows a change in the frictional force when it was pulled in order of carpet to wooden floor straightway by a string tied from the walker to the motor.

The frictional power when a sensor was moved from carpet to wooden floor is shown in the Y shaft direction.

The moving time of the sensor in the X shaft direction is shown in seconds.

FIG. 6 is a chart when a mechanical gait stabilizer isn't used, and there is a moment when tension becomes ON from on the carpet (J) to the wooden floor (K), and it can be said that there is a danger of turnover.

FIG. 7 is a chart in the case of using a mechanical gait stabilizer.

The decline of the tension isn't seen even if it is moved from a carpet (J) to a wooden floor (K).

There is a calculation of the frictional power by the method, which is usually used, Table b 2 shown in FIG. 7 expresses how the substantially constant frictional force is received in all the measurement sections by using a mechanical gait stabilizer.

Use possibility in industry.

Using this invention of mechanical gait stabilizer, a walker may use in constant frictional force against floor surface.

Therefore by a usage of mechanical gait stabilizer attached walker, it controls the movement of the wheels of the walker, and continues to move stably without using any handle or electrical brake system by user's hands or feet, and achieve stability of users' walk.

Then, the handicapped persons who must rely on the care, such as specially the aged handicapped persons who are unfavorable to use a brake judging in a moment by oneself, can use reliable walkers.

Therefore they can become gait possible and fulfill life independence.

Effect of the Invention

As explained above, this invention, the mechanical gait stabilizer gives substantially constant friction force that could be given to any floor surfaces by the effect of the brake structure, which automatically set on and off a brake on a wheel optionally.

Therefore through a usage of a mechanical gait stabilizer attached to a walker, the movement of the wheels is controlled.

And when the friction force from a floor is changing, the mechanical gait stabilizer attached to a walker continues to move stably without using any handle or electrical brake system in one's will, and achieve stability of users' gait.

1. A mechanical gait stabilizer comprising;
a sensor to detect frictional force for a walker, which is providing a frame to keep user's body weight and wheels on the floor surface in times of moving,
a transmission structure that transmits a frictional force in accordance with a change of a frictional force, which is detected by said sensor, and
a brake structure, which automatically set on and off a brake on a wheel where said mechanical gait stabilizer is optionally attached to.

2. A mechanical gait stabilizer comprising;
a sensor to detect frictional force for a walker, which is providing a frame to keep user's body weight and wheels on the floor surface in times of moving,
a supporting structure that stabilize and keep firm said sensor within a defined area of back and forth, around, and up-and-down,
a transmission structure that transmits a frictional force in accordance with a change of a frictional force, which is detected by said sensor, and
a brake structure, which automatically set on and off a brake on a wheel where said mechanical gait stabilizer is optionally attached to.

3. Mechanical walker stabilizer according to claim 1 or 2 comprising, at least one sled and at least spring onto said sensor as parts for a detection devise.

4. Mechanical walker stabilizer according to claim 1, 2 or 3 comprising, at least one lever as a device for leverage to transmits a change of springs.

5. Mechanical walker stabilizer according to claim 1, 2, 3 or 4 comprising, mechanical brake for a brake system.
